(19) United States
(12) Patent Application Publication
(10) Pub. No.: US 2007/0156915 A1
(43) Pub. Date: Jul. 5, 2007

(54) INFORMATION PROCESSING APPARATUS, INFORMATION PROCESSING METHOD, AND PROGRAM

(75) Inventor: Hideo NEISHI, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Shinagawa-Ku (JP)

(21) Appl. No.: 11/616,466

(22) Filed: Dec. 27, 2006

(30) Foreign Application Priority Data
Jan. 5, 2006 (JP) 2006-000648

(51) Int. Cl. G06F 15/16

(52) U.S. Cl. 709/230

(57) ABSTRACT

An information processing apparatus is connected to a network and performs processing for communications with other apparatus connected to the network. The information processing apparatus includes a first processor and a second processor. The first processor is configured to perform, in response to a request from an application program, a first process in an upper layer of a network protocol stack made up of a plurality of layers constituting the processing for communications. The second processor is configured to perform a second process of the network protocol stack in accordance with a result of the first process. The first processor carries out the first process using an application program interface called up by the application program.

### CROSS REFERENCES TO RELATED APPLICATIONS

The present invention contains subject matter related to Japanese Patent Application JP 2006-000648 filed with the Japanese Patent Office on Jan. 5, 2006, the entire contents of which being incorporated herein by reference.

### BACKGROUND OF THE INVENTION

1. Field of the Invention

The present invention relates to an information processing apparatus, an information processing method, and a program. More particularly, the invention relates to an information processing apparatus, an information processing method, and a program for conducting communications by use of TOE (TCP Offload Engine).

2. Description of the Related Art

There exists TCP/IP (Transmission Control Protocol/Internet Protocol), a set of communications protocols for use on networks such as the Internet. The TCP/IP protocol used to be implemented by software (i.e., software programs) running on UNIX (registered trademark) Today, most of the processes pursuant to the protocol are still carried out by software. However, with more and more data required to be transferred over networks, there has been a growing demand for having TCP/IP processing carried out at higher speeds than before.

That demand has been met illustratively by the solution called TOE (TCP Offload Engine). This is a technique having an independent chip (dedicated hardware) take over the TCP/IP processing that used to consume CPU (central processing unit) resources on the host side. The TOE technique lets the CPU resources of the host solely take care of the processing of application programs. The result is a reduced process load on the CPU of the host as well as an enhanced speed of the TCP/IP processing.

Where a network protocol stack (also called the protocol stack) such as TCP/IP is implemented, the protocol stack and an API (application program interface) are incorporated in the kernel of the OS (operating system) in a manner inseparable from one another.

The protocol stack refers to a set of protocols each playing a different role in handling communications that often involves multiple protocols. In the case of TCP/IP, TCP (Transmission Control Protocol) and IP (Internet Protocol) were initially independent of each other but are generally used in combination. For that reason, these protocols are presented as a protocol stack. In general, the software that implements hierarchically defined protocols is also structured hierarchically. In that respect, the protocol stack also refers to such software-based implementations. In the description that follows, the protocol suite made up of a plurality of protocols such as TCP/IP and UDP/IP (User Datagram Protocol/Internet Protocol) and the software implementing these protocols will both be referred to as the protocol stack.

The API is a set of commands and functions that can be used to develop software destined for a given platform. More specifically, the Socket API is defined between the application layer and the transport layer and deals with network communications and interprocess communications (IPC). If the OS is UNIX, the Socket API is implemented by use of a BSD socket; if the OS is Windows (registered trademark), then the Socket API is implemented using WinSock (Windows Sockets).

That is, the TCP/IP processing was heretofore carried out with the protocol stack and the API linked inseparably with one another.

In a separate development, there exists transmission apparatus (such as one disclosed in Japanese Patent Laid-open No. 2003-229905) which works as follows: after input AV (audio visual) data is placed into an AV buffer circuit, a packet processing device of the apparatus creates 32-kilobyte jumbo packet data. Based on CPU-generated header data, the packet processing device divides the jumbo packet data into Ethernet (registered trademark) packets of up to 1,518 bytes each. The packets thus created are then transmitted.

### SUMMARY OF THE INVENTION

A given protocol stack, when implemented, is linked inseparably with the corresponding API in the kernel of the OS. That means it may be impossible to offer diverse APIs to address a particular protocol stack.

Illustratively, the above-cited transmission apparatus (in Japanese Patent Laid-open No. 2003-229905) divides generated data into packets for transmission. Because of the inseparable linkage between the protocol stack and the API, other differently designed APIs may not be utilized.

The close connection between the protocol stack and the API has posed another disadvantage. If either the protocol stack or the API fails, the other side is directly affected by the fault.

Furthermore, it has been impossible to select only the necessary API from among the available APIs and load it into memory. That is, utilization efficiency of the memory has remained poor.

The present invention has been made in view of the above circumstances and provides arrangements such as to offer diverse APIs to deal with a particular protocol stack.

In carrying out the present invention and according to one embodiment thereof, there is provided an information processing apparatus which is connected to a network and which performs processing for communications with other apparatus connected to the network, the information processing apparatus including: a first processor configured to perform, in response to a request from an application program, a first process in an upper layer of a network protocol stack made up of a plurality of layers constituting the processing for communications; and a second processor configured to perform a second process of the network protocol stack in accordance with a result of the first process, wherein the first processor carries out the first process using an application program interface known as an API called up by the application program.

In the description that follows, the term “network” will refer to a setup that connects at least two apparatuses in a manner enabling one apparatus to transmit information to the other apparatus. The apparatuses communicating with one another through the network may either be independent of one another or constitute internal blocks that form a single piece of equipment.

In the ensuing description, the term “communication” will refer to an arrangement that functions wirelessly or in wired fashion. The arrangement may alternatively work in a manner in which wired communications performed in one zone are taken over by wireless communications in another zone. The arrangement may further work in such a manner that one apparatus communicates in wired fashion with another apparatus which in turn communicates wirelessly with yet another apparatus, and so on.

Preferably, the above information processing apparatus according to an embodiment of the present invention may include a supervisor configured to supervise status of the second processor in order to accumulate information about the status of the second processor.

Preferably, the first processor may select the API necessary for performing the first process and carrying out the first process by loading the selected API.

The API mentioned in conjunction with the inventive information processing apparatus may preferably be a socket API.

The network protocol stack mentioned in conjunction with the inventive information processing apparatus may be the TCP/IP.

Preferably, the information processing apparatus according to an embodiment of the present invention may further include a third processor configured to perform the second process if the second processor fails, wherein, in case of the failure of the second processor, the first processor may acquire status in effect before the failure from the application program and carry out the first process in accordance with the acquired status, and wherein the third processor may perform the second process in accordance with a result of the first process.

Preferably, the information processing apparatus according to an embodiment of the present invention may further include: a third processor configured to perform the first process if either the first processor or the second processor fails; and a fourth processor configured to perform the second process if either the first processor or the second processor fails, wherein, in case of the failure of either the first processor or the second processor, the third processor may acquire status in effect before the failure from the application program and carry out the first process in accordance with the acquired status, and wherein the fourth processor may perform the second process in accordance with a result of the first process.

According to another embodiment of the present invention, there is provided an information processing method for use with an information processing apparatus which is connected to a network and which performs processing for communications with other apparatus connected to the network, the information processing method including the steps of: performing, in response to a request from an application program, a first process in an upper layer of a network protocol stack made up of a plurality of layers constituting the processing for communications; and performing a second process of the network protocol stack in accordance with a result of the first process, wherein the first process performing step carries out the first process using an application program interface known as an API called up by the application program.

According to a further embodiment of the present invention, there is provided a program for causing an information processing apparatus connected to a network to perform processing for communications with other apparatus connected to the network, the program including the steps of: performing, in response to a request from an application program, a first process in an upper layer of a network protocol stack made up of a plurality of layers constituting the processing for communications; and performing a second process of the network protocol stack in accordance with a result of the first process, wherein the first process performing step carries out the first process using an application program interface known as an API called up by the application program.

As outlined above, where the information processing apparatus, information processing method, or program according to an embodiment of the present invention is in use, a first process in an upper layer of a network protocol stack made up of a plurality of layers constituting communication processing is carried out in response to a request coming from an application program. A second process of the network protocol stack is carried out in accordance with a result of the first process. The first process is performed by use of an application program interface (API) called up by the application program.

As described, the above embodiments of the present invention can offer diversely designed APIs to deal with a particular protocol stack.

### BRIEF DESCRIPTION OF THE DRAWINGS

FIG. 1 is a block diagram showing a typical hardware structure of a personal computer;

FIG. 2 is a block diagram showing a typical hardware structure of a communication device;

FIG. 3 is a block diagram showing how the personal computer is implemented as an embodiment of the present invention;

FIG. 4 is a schematic view explanatory of an interface between a user module and a protocol stack module;

FIG. 5 is a flowchart of steps constituting a data transmitting process performed by the personal computer;

FIG. 6 is a schematic view explanatory of how two protocol stack modules are connected to a single middleware instance in the personal computer; and

FIG. 7 is a schematic view explanatory of how middleware instances and protocol stack modules are connected on a one-to-one basis in the personal computer.

### DETAILED DESCRIPTION OF THE PREFERRED EMBODIMENTS

What is described below as the preferred embodiments of the present invention with reference to the accompanying drawings corresponds to the appended claims as follows: the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention described hereunder has a specifically corresponding claim, this does not mean that the example in question is limited to that claim or has no relevance to other claims.

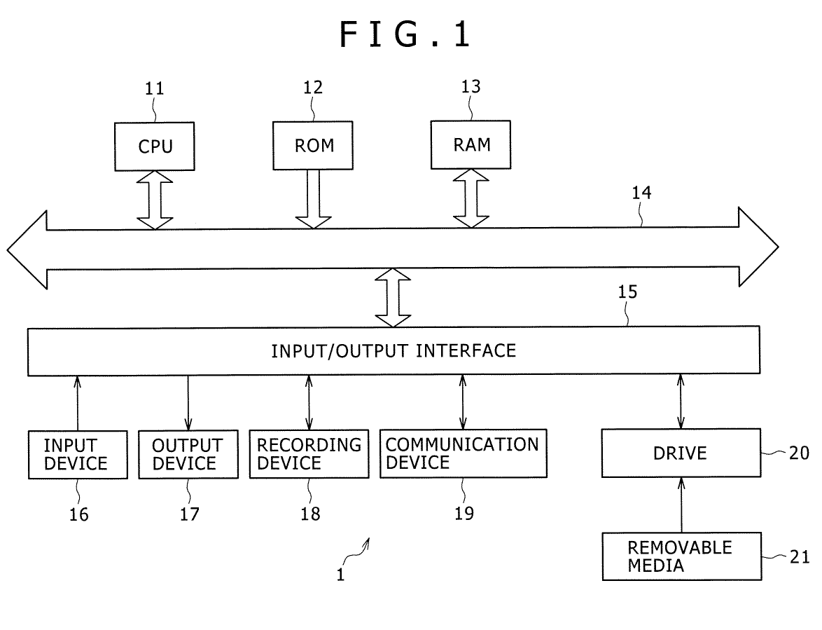

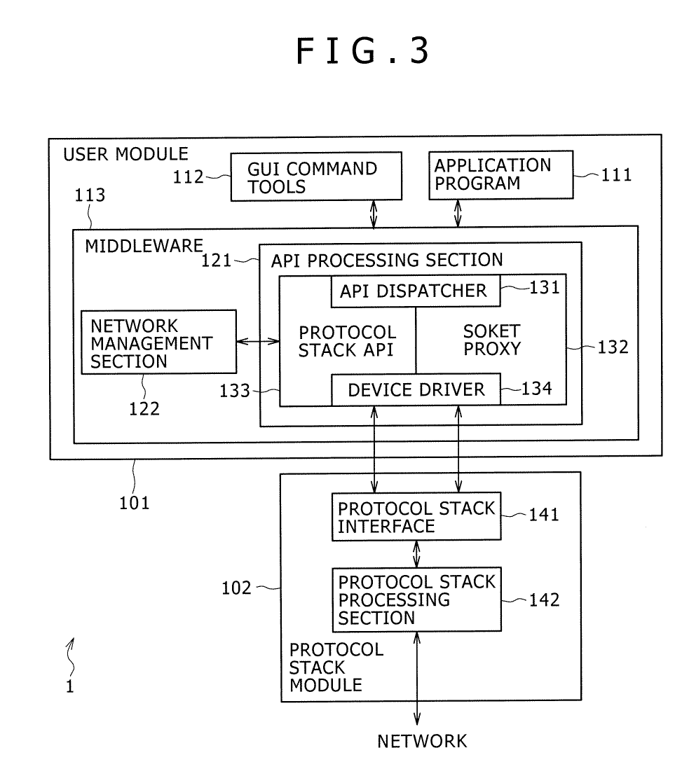

One embodiment of the present invention is an information processing apparatus (e.g., personal computer 1 in FIG. 1) including: a first processor (e.g., API processing section 121 in FIG. 3) configured to perform, in response to a request from an application program, a first process in an upper layer of a network protocol stack made up of a plurality of layers constituting communication processing; and a second processor (e.g., protocol stack processing section 142 in FIG. 3) configured to perform a second process of the network protocol stack in accordance with a result of the first process; wherein the first processor carries out the first process using an application program interface known as an API called up by the application program.

Preferably, the above information processing apparatus according to an embodiment of the present invention may include a supervisor (e.g., network management section 122 in FIG. 3) configured to supervise status of the second processor in order to accumulate information about the status of the second processor.

Preferably, the first processor may select the API needed to perform the first process and carry out the first process by loading the selected API.

The API may preferably be a socket API.

The network protocol stack may preferably be the TCP/IP.

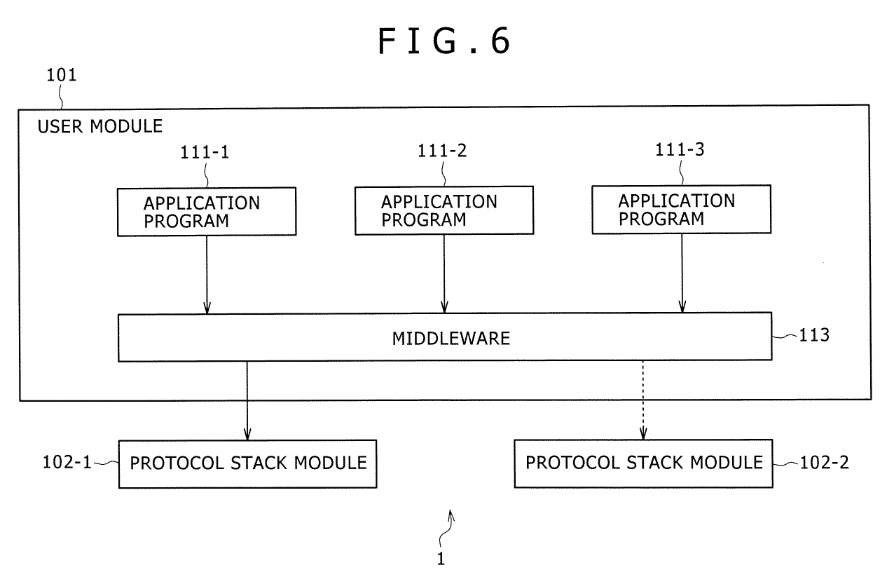

Preferably, the information processing apparatus according to an embodiment of the present invention may further include a third processor (e.g., protocol stack processing section 142 as part of a protocol stack module 102-2 in FIG. 6) configured to perform the second process if the second processor (e.g., protocol stack processing section 142 as part of a protocol stack module 102-1 in FIG. 6) fails; wherein, in case of the failure of the second processor, the first processor may acquire status in effect before the failure from the application program and carry out the first process in accordance with the acquired status; and wherein the third processor may perform the second process in accordance with a result of the first process.

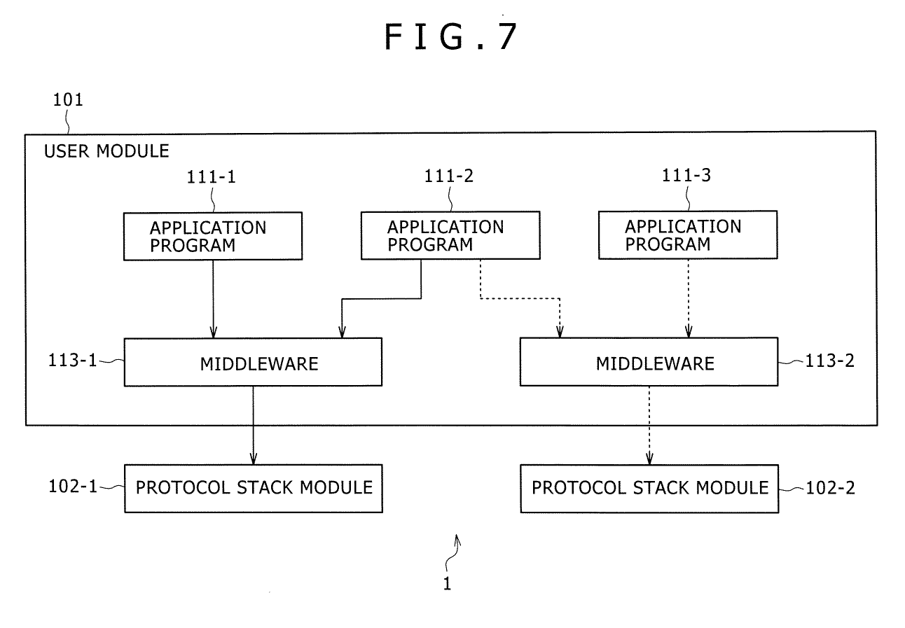

Preferably, the information processing apparatus according to an embodiment of the present invention may further include: a third processor (e.g., API processing section 121 as part of middleware 113-2 in a user module 101 of FIG. 7) configured to perform the first process if either the first processor (e.g., API processing section 121 as part of middleware 113-1 in the user module 101 of FIG. 7) or the second processor (e.g., protocol stack processing section 142 as part of the protocol stack module 102-1 in FIG. 7) fails; and a fourth processor (e.g., protocol stack processing section 142 as part of a protocol stack module 102-2 in FIG. 7) configured to perform the second process if either the first processor or the second processor fails; wherein, in case of the failure of either the first processor or the second processor, the third processor may acquire status in effect before the failure from the application program and carry out the first process in accordance with the acquired status; and wherein the fourth processor may perform the second process in accordance with a result of the first process.

Another embodiment of the present invention is an information processing method or a program including the steps of: performing (e.g., in step S12 of FIG. 5), in response to a request from an application program, a first process in an upper layer of a network protocol stack made up of a plurality of layers constituting communication processing; and performing (e.g., in step S13 of FIG. 5) a second process of the network protocol stack in accordance with a result of the first process; wherein the first process performing step carries out the first process using an application program interface known as an API called up by the application program.

The program as another embodiment of the present invention may be recorded illustratively on a suitable recording medium (e.g., removable media 21 in FIG. 1).

Preferred embodiments of the present invention will now be described with reference to the accompanying drawings.

FIG. 1 is a block diagram showing a typical hardware structure of a personal computer 1.

In the personal computer 1 of FIG. 1, a CPU (central processing unit) 11 carries out diverse processes in accordance with programs which are stored in a ROM (read-only memory) 12 or which have been loaded from a recording device 18 into a RAM (random access memory) 13. The RAM 13 may further accommodate data needed by the CPU 11 in executing its various processes.

The CPU 11, ROM 12, and RAM 13 are interconnected via a bus 14. An input/output interface 15 is also connected to the bus 14.

The input/output interface 15 is further connected to an input device 16, an output device 17, a recording device 18, and a communication device 19. The input device 16 is typically made up of a keyboard and a mouse; the output device 17 is illustratively composed of speakers and a display such as an LCD (liquid crystal display); and the recording device 18 is generally constituted by a hard disk drive.

The communication device 19 is composed illustratively of an NIC (network interface card) that controls processing for communications with other blocks over a network. Details of the communication device 19 will be discussed later.

A drive 20 is connected as needed to the input/output interface 15. The drive 20 is mounted with such removable media 21 as a magnetic disk, an optical disk, a magneto optical disk or a semiconductor memory accordingly. Computer programs are retrieved from the mounted medium and installed as occasion demands to the recording device 18.

The hardware structure of the personal computer 1 is not limited to that which is illustrated in FIG. 1. The personal computer 1 may be structured in many other ways provided it includes the functional makeup equivalent to a user module 101 in FIG. 3, to be described later.

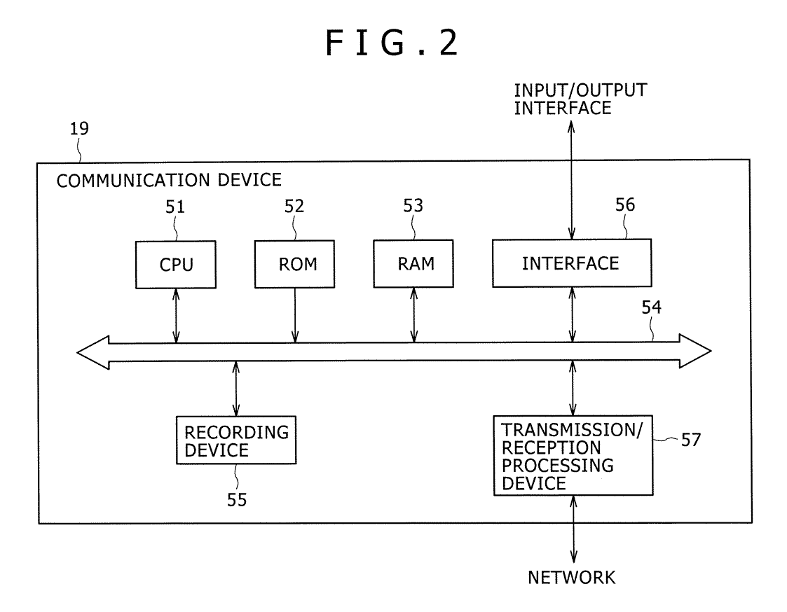

FIG. 2 is a block diagram showing a typical hardware structure of the communication device 19.

The communication device 19 is connected to the input/output interface 15 (FIG. 1). As such, the communication device 19 acquires data sent from the CPU 11 (FIG. 1), forwards the acquired data over a network to some other networked device, receives data from the other networked device, and feeds the data thus received to the CPU 11. Furthermore, the communication device 19 performs processing on the protocol stack such as the TCP/IP (i.e., specific processes are carried out on the protocol stack).

The communication device 19 is structured to include a CPU 51, a ROM 52, a RAM 53, a recording device 55, an interface 56, and a transmission/reception processing device 57. The CPU 51, ROM 52, RAM 53, recording device 55, interface 56, and transmission/reception processing device 57 are interconnected via a bus 54.

In the communication device 19 of FIG. 2, the CPU 51 carries out diverse processes in accordance with programs which are held in the ROM 52 or which have been loaded from the recording device 55 into the RAM 53. The RAM 53 may further accommodate data needed by the CPU 51 in executing its various processes.

Under control of the CPU 51, the transmission/reception processing device 57 performs processes necessary for transmitting data over the network to some other networked device or for receiving data from the other networked device.

The hardware structure of the communication device 19 is not limited to that which is illustrated in FIG. 2. The communication device 19 may be structured in many other ways provided it includes the functional makeup equivalent to a protocol stack module 102 in FIG. 3, to be described later.

FIG. 3 is a block diagram showing how the personal computer 1 is implemented as an embodiment of the present invention.

The personal computer 1 communicates with other devices connected to the network. As such, the personal computer 1 works as an information processing apparatus according to the invention.

The personal computer 1 is structured to include the user module 101 and protocol stack module 102. Illustratively, the user module 101 corresponds to the functional makeup of the personal computer 1 and the protocol stack module 102 represents that of the communication device 19.

Because the personal computer 1 of this embodiment has the above-described hardware structure of FIG. 1, the user module 101 is implemented illustratively as a program (software) to be executed by the CPU 11 (FIG. 1). Alternatively, if the personal computer 1 is structured in a manner different from the hardware structure of FIG. 1, the user module 101 may be implemented as a hardware unit or as a combination of software and hardware.

Because the communication device 19 has the hardware structure of FIG. 2, the protocol stack module 102 is implemented illustratively as a program (software) to be carried out by the CPU 51 (FIG. 2). Alternatively, if the communication device 19 is structured in a manner different from the hardware structure of FIG. 2, the protocol stack module 102 may be implemented as a hardware unit or as a combination of software and hardware.

The user module 101 is recorded illustratively on the recording device 18 (FIG. 1). As occasion demands, the user module 101 is loaded into the RAM 13 (FIG. 1) and executed by the CPU 11 (FIG. 1).

Upon execution of the user module 101, it is not mandatory to load the entire module into the RAM 13. Only the necessary functions of the user modules 101 may be selectively loaded into the RAM 13 and executed.

The user module 101 is structured to include application programs 111, GUI command tools, and middleware 113.

The application programs 111 typically include a web browser, a mailer (i.e., an application program for sending, receiving and managing e-mails), and other programs that are operated by the user. In response to the user's operations, the application programs 111 supply the middleware 113 with commands (referred to as API calls) to designate the API for carrying out the processes corresponding to the operations.

The GUI command tools 112 are illustratively application programs used to supervise network operations and to debug programs being developed. In response to the user's operations, the GUI command tools 112 supply the middleware 113 with the API calls corresponding to the operations.

The middleware 113 represents software that offers specific functions such as communication-related capabilities to each of the application programs 111 and GUI command tools 112. Illustratively, the middleware 113 offers the functions associated with the protocol stack module 102, to be discussed later.

The middleware 113 is structured to include an API processing section 121 and a network management section 122.

The API processing section 121 carries out the processes corresponding to the API calls coming from the application programs 111 or GUI command tools 112. The results of the processes are sent from the API processing section 121 to the protocol stack module 102.

The API, which was linked inseparably to the protocol stack illustratively in the kernel of the OS, is now separated from the protocol stack in the case of this embodiment. For that reason, the API processing section 121 does not perform processes associated with the protocol stack (protocol stack processing is carried out by a protocol stack processing section 142, to be described later).

In other words, if the model of communication functionality (communication processing) is conceived in terms of a hierarchically layered structure, the API processing section 121 may be said to carry out upper-layer processes of the protocol stack such as the TCP/IP.

As will be discussed later in more detail, the results of the processes performed by the API processing section 121 are commands (also called protocol stack commands) and data (e.g., AV (audio visual) data). These results are fed to the protocol stack module 102, as indicated by two lines (a command bus and a data bus, to be described later) drawn between the user module 101 and the protocol stack module 102 in FIG. 3.

The API processing section 121 is structured to include an API dispatcher 131, a socket proxy 132, a protocol stack API 133, and a device driver 134.

In the setup of FIG. 3, the protocol stack API 133 is shown as a typical extended API. Alternatively, other extended APIs may be added. As another alternative, the API processing section 121 may be structured to include the API dispatcher 131, socket proxy 132, and protocol stack API 133 while excluding the device driver 134. In this case, the device driver 134 will be included in the middleware 113.

Given API calls from the application programs 111 or from the GUI command tools 112, the API dispatcher 131 forwards the calls either to the socket proxy 132 or to the protocol stack API 133 for processing. This makes it possible to have the appropriate processes carried out as commanded.

The socket proxy 132 is a standard API that provides capabilities to transmit and receive data through the use of a socket API such as the BSD socket running on UNIX (registered trademark) or Winsock running on Windows (registered trademark). Given API calls from the API dispatcher 131, the socket proxy 132 performs the processes corresponding to the calls and feeds the resulting data to the device driver 134. Also in response to the API calls from the API dispatcher 131, the socket proxy 132 generates protocol stack commands destined for the protocol stack module 102. The protocol stack commands thus generated are fed to the device driver 134.

The protocol stack API 133 is an extended API dedicated to the protocol stack module 102. Illustratively, the protocol stack API 133 provides functions related to the protocol stack module 102 such as an SNMP (Simple Network Management Protocol) interface. Given API calls from the API dispatcher 131, the protocol stack API 133 carries out the processes corresponding to the received calls and feeds the data resulting from the processing to the device driver 134. Also in response to the API calls from the API dispatcher 131, the protocol stack API 133 generates protocol stack commands destined for the protocol stack module 102 and supplies the protocol stack commands thus generated to the device driver 134.

That is, the socket proxy 132 and protocol stack API 133 do not perform processes associated with the protocol stack such as the TCP/IP.

That means the processing executed by the API processing section 121 is not dependent of the protocol stack. For that reason, extended APIs (e.g., APIs other than the protocol stack API 133) may be added as desired without regard to the protocol stack in use. In other words, the API processing section 121 can offer diverse APIs in connection with the protocol stack.

The device driver 134 supplies the protocol stack module 102 with the data (e.g., AV data) coming either from the socket proxy 132 or from the protocol stack API 133. Furthermore, the device driver 134 supplies the protocol stack module 102 with the protocol stack commands coming either from the socket proxy 132 or from the protocol stack API 133.

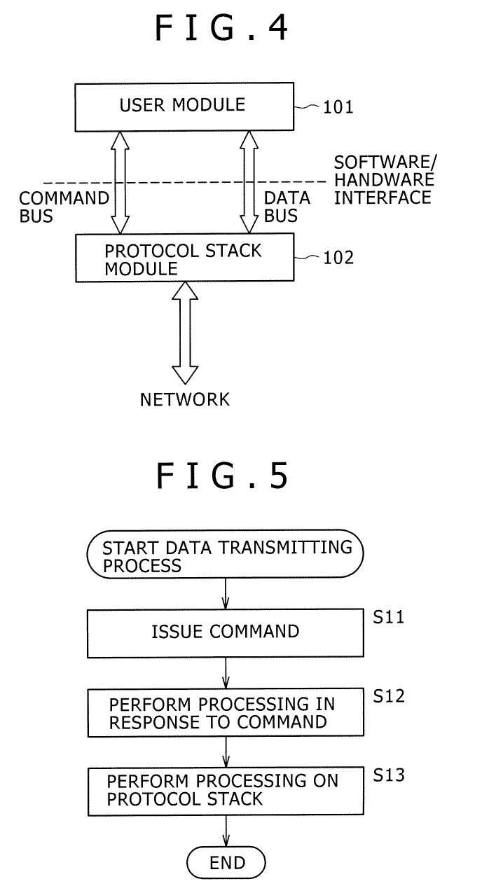

Details of the interface between the device driver 134 (user module 101) and a protocol stack interface 141 (protocol stack module 102) will be discussed later in reference to FIG. 4.

The network management section 122 supervises status of the protocol stack module 102 by way of the API processing section 121 and accumulates information about the status. Illustratively by supervising the protocol stack module 102 for status, the network management section 122 accumulates information about logs and errors such as network loads, loads on the protocol stack module 102, and whether or not a new protocol stack module 102 has been added.

If the command coming from the GUI command tools 112 (or application program 111) is a command for the monitoring or managing of the protocol stack module 102, the network management section 122 supplies the GUI command tools 112 (or application program 111) with the information the section 122 accumulated regarding the status of the protocol stack module 102. At this point, the network management section 122 may analyze or process the accumulated information before supplying it to the GUI command tools 112 (or application program 111).

The GUI command tools 112 (or application program 111) cause the API processing section 121 to display the information sent from the network management section 122 illustratively on the screen of the output device 17. This allows the user to know the status of the protocol stack module 102 and of the network.

The protocol stack module 102 is recorded typically in the ROM 52 (FIG. 2) or on the recording device 55 (FIG. 2). As needed, the protocol stack module 102 is loaded into the RAM 53 (FIG. 2) and executed by the CPU 51 (FIG. 2).

The protocol stack module 102 is structured to include the protocol stack interface 141 and protocol stack processing section 142.

The protocol stack processing section 142 performs protocol stack processing based on the data such as AV data or on the protocol stack commands coming from the device driver 134 (user module 101) through the protocol stack interface 141. The protocol stack processing section 142 transmits the processed data (i.e., packets) over the network to some other device connected to the network.

The protocol stack processing section 142 performs protocol stack processing by acquiring suitable functions from the API processing section 121 as occasion demands by way of the protocol stack interface 141 and device driver 134.

In other words, if the model of communication functionality (communication processing) is conceived in terms of a hierarchically layered structure, the protocol stack processing section 142 may be said to carry out lower-layer processes of the API processing section 121, such as processes regarding the protocol stack (e.g., TCP/IP).

The protocol stack processing typically includes checksum verifications, IP fragmentation, IP defragmentation, gaining access to websites, packet retransmissions upon packet losses, and routing processes.

The checksum verifications, IP fragmentation and IP defragmentation to be handled by the protocol stack processing section 142 are typically implemented by hardware. Accessing of websites, packet retransmissions upon packet losses, and routing processes also to be addressed by the protocol stack processing section 142 are implemented illustratively by programs (software) performed by the CPU 51 (FIG. 2). That is, although the protocol stack module 102 is typically structured by programs (software) executed by the CPU 51 (FIG. 2), the protocol stack module 102 may alternatively be implemented as a hardware unit or as a combination of software and hardware if the communication device 19 is structured in a manner different from the hardware structure of FIG. 2.

In other words, this embodiment has the protocol stack processing carried out not by the CPU 11 (FIG. 1) but by the CPU 51 (FIG. 2). This arrangement is intended to alleviate the processing load on the CPU 11.

As described, the API is separated from the protocol stack in the personal computer 1. Thus it is the protocol stack module 102, not the user module 101, that takes over the protocol stack processing.

Described below with reference to FIG. 4 is the interface between the user module 101 and the protocol stack module 102.

As shown in FIG. 4, the protocol stack module 102 has two interfaces, one for commands and the other for data. These two interfaces allow the protocol stack module 102 to connect with the user module 101 via a command bus and a data bus. More specifically, the command bus shown on the left in FIG. 4 and the data bus on the right link the user module 101 with the protocol stack module 102.

The command bus complies illustratively with 32-bit SRAM/SSRAM (static random access memory/synchronous SRAM) criteria. As such, the command bus is used to transfer commands (protocol stack commands) between the user module 101 and the protocol stack module 102; the command bus is also used to transfer between the two modules the data that need not be transferred at high speed.

The data bus complies illustratively with 32/64-bit selectable DMA (direct memory access) criteria. As such, the data bus serves to transfer large quantities of data such as AV data at high speed between the user module 101 and the protocol stack module 102.

Alternatively, the command bus alone may be used to transfer commands or data between the user module 101 and the protocol stack module 102. In this case there is no need for a data bus.

In the personal computer 1, as discussed above, it is the protocol stack module 102, not the user module 101, that carries out protocol stack processing. An example of the processing is described below in reference to the flowchart of FIG. 5; this is a data transmitting process performed by the personal computer 1 in FIG. 3. This process is started illustratively when the user issues through the user interface a command to transmit data.

In step S11, the application program 111 issues a suitable command in response to the user's operation. The issued command is sent from the application program 111 to the API processing section 121.

Illustratively, if in step S11 the application program 111 is running on a UNIX (registered trademark) OS in keeping with the user's operation, then a BSD socket command is issued by the program 111; if the application program 111 is running on a Windows (registered trademark) OS, then a Winsock command is issued. The BSD socket command or Winsock command thus issued is sent to the API processing section 121.

In step S12, the API processing section 121 receives the API call from the application program 111 and performs the process corresponding to the call. The data or command (protocol stack command) resulting from the process is sent from the API processing section 121 to the protocol stack module 102 (protocol stack processing section 142)

Illustratively, if in step S12 the API processing section 121 is running on a UNIX (registered trademark) OS, then the section 121 performs an appropriate process corresponding to the BSD socket command coming from the application program 111 and supplies the data (e.g., AV data) derived from the process to the protocol stack module 102 (protocol stack processing section 142) through the data bus. The API processing section 121 also generates a protocol stack command corresponding to the BSD socket command coming from the application program 111 and forwards the protocol stack command thus generated to the protocol stack module 102 (protocol stack processing section 142) through the command bus.

In the setup above, the API is separated from the protocol stack. For that reason, the API processing section 121 does not perform processing on the protocol stack such as the TCP/IP.

In step S13, the protocol stack processing section 142 performs protocol stack processing based on the data or the protocol stack command fed from the API processing section 121 via the data bus. The protocol stack processing section 142 transmits the processed data (i.e., packets) over the network to other devices connected to the network. The data transmitting process is then terminated.

Illustratively in step S13, the protocol stack processing section 142 performs such processes as checksum verifications, IP fragmentation, IP defragmentation, accessing of websites, packet retransmissions upon packet losses, or routing processes on the AV data supplied from the API processing section 121 via the data bus in accordance with the protocol stack command from the section 121 via the command bus. The protocol stack processing section 142 transmits the data (packets) resulting from the processing over the network to other devices connected to the network.

That is, with the API separated from the protocol stack, the protocol stack processing section 142 carries out the protocol stack processing.

In the personal computer 1, as described, the user module 101 (API processing section 121) does not perform processes associated with the protocol stack; the protocol stack processing is carried out by the protocol stack module 102 (protocol stack processing section 142).

The API that used to be linked inseparably to the protocol stack illustratively in the kernel of the OS is now separated from the protocol stack according to an embodiment of the present invention. Thus it is the protocol stack processing section 142, not the API processing section 121, that executes protocol stack processing. The separation of the API from the protocol stack makes it possible to offer diverse APIs with regard to the protocol stack such the TCP/IP or the UDP/IP.

The personal computer 1 may be designed to have a plurality of protocol stack modules 102 or multiple units of middleware 113. With this arrangement (fault-tolerant design) in place, if the main circuit develops a fault, it may be replaced by a standby circuit in order to bypass the failure.

The middleware 113 may generate one or two instances on the host equipment (i.e., personal computer 1). Thus the personal computer 1 is applicable to one of two cases: one in which one instance of the middleware 113 is connected to two protocol stack modules 102, and one in which the instances of the middleware 113 are connected to the protocol stack modules 102 on a one-to-one basis.

Described below with reference to FIG. 6 is an example in which the instance of one unit of middleware 113 is connected to two protocol stack modules 102.

In the personal computer 1 of FIG. 6, the user module 101 is structured to include application programs 111-1 through 111-3 and middleware 113.

In the example of FIG. 6, the application programs 111-1 through 111-3 are active and communicate with some other (remote) device on the network through the middleware 113 and by way of a protocol stack module 102-1 that is part of the main circuit. In this setup, a protocol stack module 102-2 constitutes part of the standby circuit and is thus inactive in terms of processing.

If the protocol stack module 102-1 of the main circuit fails in the personal computer 1, the ongoing session is terminated. In such a case, the middleware 113 initializes the protocol stack module 102-2 of the standby circuit to reestablish a session with the remote device. Because the packets being buffered in the protocol stack module 102-1 of the main circuit are discarded in case of failure, the middleware 113 tells each of the application programs 111-1 through 111-3 which packets have already been sent. On the basis of the notification from the middleware 113, the application programs 111-1 through 111-3 each retransmit the discarded packets.

Described below with reference to FIG. 7 is an example in which the instances of the middleware 113 and the protocol stack modules 102 are connected on a one-to-one basis.

In the personal computer 1 of FIG. 7, the user module 101 is structured to include application programs 111-1 through 111-3, middleware 113-1, and middleware 113-2.

In the example of FIG. 7, the application programs 111-1 and 111-2 are active and communicate with a remote device on the network through the middleware 113-1 and the protocol stack module 102-1, both part of the main circuit. The middleware 113-2 and protocol stack module 102-2 constitute part of the standby circuit. The application program 111-3 remains inactive.

If the protocol stack module 102-1 of the main circuit fails in the personal computer 1, the ongoing session is terminated and the packets being buffered are discarded. Then the application program 111-2 that was transmitting the packets reestablishes a session with the remote device using the middleware 113-2 and protocol stack module 102-2 of the standby circuit and retransmits the discarded packets.

If the middleware 113-1 of the main circuit fails, the ongoing session is also terminated and the packets being buffered are discarded as in the case of the failure in the protocol stack module 102-1 of the main circuit. Then the application program 111-2 that was transmitting the packets reestablishes a session with the remote device using the middleware 113-2 and protocol stack module 102-2 of the standby circuit and retransmits the discarded packets.

As described, the personal computer 1 is furnished with two protocol stack modules 102-1 and 102-2. In case the protocol stack module 102-1 as part of the main circuit fails, the processes that were performed by the failed module are taken over by the protocol stack module 102-2 of the standby circuit so that the processing will proceed uninterrupted.

When the API that used to be linked inseparably with the protocol stack is separated from the latter illustratively in the kernel of the OS, it is possible to separate the protocol stack processing from what the API does. In case of a failure in the protocol stack module 102-1 of the main circuit during protocol stack processing, the processes being done by the module 102-1 are taken over by the protocol stack module 102-2 of the standby circuit. This arrangement minimizes adverse effects stemming from the failure. In the event of a failure, the middleware 113 and the protocol stack module 102 may be checked separately in order to determine clearly which of them has failed. This makes it possible to detect the probable cause of the fault more quickly than before.

If the personal computer 1 has resources to spare and if it is desired to raise fault tolerance on the level of the middleware 113, then the setup of FIG. 7 involving two units of middleware 113 is preferred over the structure of FIG. 6 in which there is one middleware 113.

Thus with the API separated from the protocol stack as opposed to their traditionally inseparable linkage, the protocol stack processing can be separated from the workings of the API according to an embodiment of the present invention. This makes it possible to offer various APIs with regard to a particular protocol stack. For example, diversely designed APIs regarding miscellaneous network programming may be offered to the users who are developing application programs (i.e., developers).

According to an embodiment of the present invention, the processes that were performed by the CPU 11 of the host on the protocol stack such as the TCP/IP are taken over by the CPU 51 that carries out protocol stack processing alone. This makes it possible to allocate the CPU resources on the host side solely to the processing of application programs. As a result, the processing loads on the CPU 11 of the host are alleviated and the processing on the TCP/IP is boosted in speed.

According to an embodiment of the present invention, memory resources can be effectively utilized by selectively loading the necessary function such as the socket proxy 132 or the protocol socket API 133 in response to the user's operations on the application program 111 (i.e., GUI command tools 112). That means the efficiency of memory utilization is enhanced even on equipment with insufficient resources, so that large quantities of AV data can be transmitted and received by such equipment.

Because the API that used to be linked inseparably with the protocol stack is separated from the latter according to an embodiment of the present invention, the user (i.e., developer) can freely define the interface between the API and the protocol stack.

Although the communication device 19 in FIG. 1 was shown above as a component part of the personal computer 1, this is not limitative of the present invention. Alternatively, the communication device may be provided as an independent entity as shown in the setup of FIG. 2. Illustratively, the communication device 19 in FIG. 1 may be structured to be detachable from the personal computer 1. In this case, the communication device 19 may be attached not only to the personal computer 1 but also to such diverse equipment as a video camera, an AV server or a switcher to carry out the above-described processes for network communication.

In connection with the above-described embodiment of the invention, the TCP/IP was presented above as a typical protocol stack for description purposes. Alternatively, any other suitable protocol stack such as the UDP/IP may be adopted.

According to an embodiment of the present invention, the personal computer 1 may be connected to communication equipment through serial or USB (Universal Serial Bus) arrangements for connection with the network. In this setup, the personal computer 1 may communicate through the communication equipment with other devices connected to the network. That is, the personal computer 1 carries out processes associated with the user module 101 whereas the communication equipment executes processes related to the protocol stack module 102 based on the commands or data coming from the personal computer 1 via a serial cable or a USB cable. The data (i.e., packets) resulting from the processing is then sent to another device.

The series of processes described above may be executed either by hardware or by software. For the software-based processing to take place, the programs constituting the software may be either incorporated beforehand in dedicated hardware of a computer for program execution or installed upon use from a suitable recording medium into a general-purpose personal computer or like equipment capable of executing diverse functions based on the installed programs.

The recording medium which is offered to users apart from their computers and which accommodates the above-mentioned programs is constituted not only by such removable media 21 in FIG. 1 as magnetic disks (including flexible disks), optical disks (including CD-ROM (compact disk read-only memory) and DVD (digital versatile disk)), magneto-optical disks (including MD (Mini-disk; registered trademark)), or semiconductor memory; but also by such media as the ROM 12 or the recording device 18 in FIG. 1, the latter recording media being preinstalled in the computer when offered to the users with the programs stored thereon.

The programs for carrying out the above-described series of processes may be installed as needed into the computer via such interfaces as routers or modems and through wired or wireless communication media such as local area networks, the Internet, or digital satellite broadcast links.

In this specification, the steps which describe the programs stored on the recording medium represent not only the processes that are to be carried out in the depicted sequence (i.e., on a time series basis) but also processes that may be performed parallelly or individually and not chronologically.

It should be understood by those skilled in the art that various modifications, combinations, sub-combinations and alterations may occur depending on design requirements and other factor in so far as they are within the scope of the appended claims or the equivalents thereof.

What is claimed is:

1. An information processing apparatus which is connected to a network and which performs processing for communications with other apparatus connected to said network, said information processing apparatus comprising:
a first processor configured to perform, in response to a request from an application program, a first process in an upper layer of a network protocol stack made up of a plurality of layers constituting said processing for communications; and
a second processor configured to perform a second process of said network protocol stack in accordance with a result of said first process,
wherein said first processor carries out said first process using an application program interface called up by said application program.

2. The information processing apparatus according to claim 1, further comprising a supervisor configured to supervise status of said second processor in order to accumulate information about said status of said second processor.

3. The information processing apparatus according to claim 1, wherein said first processor selects said application program interface needed to perform said first process and carries out said first process by loading the selected application program interface.

4. The information processing apparatus according to claim 1, wherein said application program interface is a socket application program interface.

5. The information processing apparatus according to claim 1, wherein said network protocol stack is the Transmission Control Protocol/Internet Protocol.

6. The information processing apparatus according to claim 1, further comprising a third processor configured to perform said second process if said second processor fails,
wherein, in case of the failure of said second processor, said first processor acquires status in effect before said failure from said application program and carries out said first process in accordance with the acquired status, and
wherein said third processor performs said second process in accordance with a result of said first process.

7. The information processing apparatus according to claim 1, further comprising:
a third processor configured to perform said first process if either said first processor or said second processor fails; and
a fourth processor configured to perform said second process if either said first processor or said second processor fails,
wherein, in case of the failure of either said first processor or said second processor, said third processor acquires status in effect before said failure from said application program and carries out said first process in accordance with the acquired status, and
wherein said fourth processor performs said second process in accordance with a result of said first process.

8. An information processing method for use with an information processing apparatus which is connected to a network and which performs processing for communications with other apparatus connected to said network, said information processing method comprising the steps of:
performing, in response to a request from an application program, a first process in an upper layer of a network protocol stack made up of a plurality of layers constituting said processing for communications; and
performing a second process of said network protocol stack in accordance with a result of said first process,
wherein said first process performing step carries out said first process using an application program interface called up by said application program.

9. A program for causing an information processing apparatus connected to a network to perform processing for communications with other apparatus connected to said network, said program comprising the steps of:
performing, in response to a request from an application program, a first process in an upper layer of a network protocol stack made up of a plurality of layers constituting said processing for communications; and
performing a second process of said network protocol stack in accordance with a result of said first process,
wherein said first process performing step carries out said first process using an application program interface called up by said application program.
